(19) United States
(12) Patent Application Publication
(10) Pub. No.: US 2026/0274293 A1
(43) Pub. Date: Sep. 17, 2026

(54) AUTONOMOUS DRIVING CONTROL SERVER AND METHOD OF CONTROLLING AUTONOMOUS DRIVING THEREIN

(71) Applicants: HYUNDAI MOTOR COMPANY, Seoul (KR); KIA CORPORATION, Seoul (KR)

(72) Inventor: Hee Gwon KIM, Gyeonggi-do (KR)

(73) Assignees: HYUNDAI MOTOR COMPANY, Seoul (KR); KIA CORPORATION, Seoul (KR)

(21) Appl. No.: 19/450,243

(22) Filed: Jan. 15, 2026

(30) Foreign Application Priority Data
Mar. 13, 2025 (KR) 10-2025-0032740

(51) Int. Cl. B60W 60/00; B60W 50/14; G01C 21/00; G01C 21/32

(52) U.S. Cl. CPC B60W 60/001; B60W 50/14; G01C 21/32; G01C 21/3807; G01C 21/387; G01C 21/3896; B60W 2050/146; B60W 2556/40; B60W 2556/45

(57) ABSTRACT

The present disclosure relates to an autonomous driving control server and a method of controlling autonomous driving. The autonomous driving control server includes a processor and a memory configured to store one or more programs executed by the processor, the processor configured to identify a non-drivable section in which a vehicle route is mismatched as a result of matching a first road map and a second road map, generate an alternative map including an alternative road for the non-drivable section, and transmit the alternative map to autonomous driving vehicles to control autonomous driving operation of the autonomous driving vehicles. And the first road map is a default map transmitted to the autonomous driving vehicles.

### CROSS-REFERENCE TO RELATED APPLICATION

This application claims priority to and the benefit of Korean Patent Application No. 10-2025-0032740, filed on Mar. 13, 2025, the disclosure of which is incorporated herein by reference in its entirety.

### BACKGROUND

### 1. Field of the Invention

The present disclosure relates to an autonomous driving control server and a method of controlling autonomous driving therein, and more specifically, to an autonomous driving control server and a method of controlling autonomous driving therein that enable driving along a new route when a non-drivable section occurs.

### 2. Discussion of Related Art

An autonomous vehicle is a vehicle capable of driving without driver intervention. Autonomous driving is designed to recognize a driving environment, plan a route, and avoid collisions with other vehicles and pedestrians. Currently, autonomous driving is divided into five levels, with level 0 indicating complete manual driving and level 5 indicating complete autonomous driving.

Autonomous driving reduces the possibility of accidents caused by driver carelessness, alleviates traffic congestion by selecting an optimized driving route, and minimizes driver intervention to provide convenience to the driver during long-distance driving or commuting.

However, autonomous driving has a problem that it is difficult to perfectly respond to a complex road situation due to technical limitations. In particular, even when there is no abnormality in a vehicle's functions during driving in an autonomous driving mode, it is difficult to follow a normal driving route to a destination due to a traffic situation, unexpected obstacles, road construction, or the like.

### SUMMARY

The various aspects of the present disclosure are directed to providing an autonomous driving control server and a method of controlling autonomous driving therein, which allows a vehicle to travel on a new route when a non-drivable section occurs.

Technical objects to be achieved by the present disclosure are not limited to that described above, and other technical objects that have not been described will be clearly understood by those skilled in the technical field to which the present disclosure pertains from the following description.

According to an aspect of the present disclosure, there is provided an autonomous driving control server, the server comprising: a processor; and a memory configured to store one or more programs executed by the processor, the processor configured to identify a non-drivable section in which a vehicle route is mismatched as a result of matching a first road map and a second road map, generate an alternative map including an alternative road for the non-drivable section, and transmit the alternative map to autonomous driving vehicles to control autonomous driving operation of the autonomous driving vehicles, and wherein the first road map is a default map transmitted to the autonomous driving vehicles.

The processor registers the non-drivable section based on determining that the non-drivable section is an unregistered non-drivable section, generates an alternative map corresponding to the non-drivable section based on the second road map, and transmits the alternative map corresponding to the non-drivable section to an autonomous driving vehicle scheduled to drive through the non-drivable section.

The processor sets a region of interest including the non-drivable section based on determining that the non-drivable section is an unregistered non-drivable section, displays a notification that the non-drivable section has occurred, and registers the non-drivable section based on receiving a register request.

The processor maps a non-drivable period input based on the register request with the registered non-drivable section and stores the non-drivable period, wherein the non-drivable period is a period during which the non-drivable section is maintained.

The processor transmits the alternative map the autonomous driving vehicles based on determining that the non-drivable section is a previously registered non-drivable section and that a driving date of an autonomous vehicle that has most recently driven along the alternative route of the non-drivable section falls within a preset non-drivable period, wherein the non-drivable period is a period during which the non-drivable section is maintained.

The processor sets a region of interest including the non-drivable section and then displays a notification that the non-drivable section has reoccurred based on determining that the driving date does not fall within the preset non-drivable period, and re-registers the non-drivable section based on receiving a re-register request.

The processor transmits the first road map to the autonomous driving vehicles based on a determination that the non-drivable section is unregistered.

The processor is configured to: confirm first non-drivable sections in a set search region by matching road maps corresponding to the search region between the first road map and the second road map, confirm second non-drivable sections corresponding to search conditions when a drivable section search period and the search region are input as the search conditions, and unregister non-drivable sections that do not overlap the first non-drivable sections among the second non-drivable sections.

For sections other than the non-drivable section, the processor transmits the first road map to the autonomous driving vehicles.

The first road map is a high-precision map for autonomous driving, and the second road map is a real-time road map that is updated in real time.

According to another aspect of the present disclosure, there is provided a method of controlling autonomous driving, the method comprising: matching a first road map with a second road map; generating an alternative map including an alternative road for a non-drivable section based on confirming the non-drivable section in which a vehicle route is mismatched as a result of matching a first road map and a second road map, and controlling autonomous driving operation of autonomous driving vehicles based on the alternative map, wherein the first road map is a default map transmitted to the autonomous driving vehicles.

Based on determining that the non-drivable section is an unregistered non-drivable section, the generating of the alternative map includes: registering the non-drivable section; and generating the alternative map corresponding to the non-drivable section from the second road map.

Based on determining that the non-drivable section is an unregistered non-drivable section, the generating of the alternative map includes: setting a region of interest including the non-drivable section and then displaying a notification that the non-drivable section has occurred; and registering a non-drivable section based on receiving a register request.

The generating of the alternative map further includes mapping a non-drivable period input based on the register request with the registered non-drivable section and storing the non-drivable period, the non-drivable period being a period during which the non-drivable section is maintained.

Based on determining that the non-drivable section is a previously registered non-drivable section, the generating of the alternative map includes transmitting the generated alternative map to the autonomous driving vehicles based on determining that a driving date of the autonomous driving vehicle that has most recently driven along the alternative route of the non-drivable section falls within a preset non-drivable period, wherein the non-drivable period is a period during which the non-drivable section is maintained.

The method further comprises: setting a region of interest including the non-drivable section and then displaying a notification that the non-drivable section has reoccurred based on determining that the driving date does not fall within the preset non-drivable period; and re-registering the non-drivable section based on receiving a re-register request.

The method further comprises: unregistering the non-drivable section; and
transmitting the first road map to the autonomous driving vehicles.

The unregistering of the non-drivable section includes: confirming first non-drivable sections in a set search region by matching road maps corresponding to the set search region between the first road map and the second road map; confirming second non-drivable sections corresponding to search conditions when a drivable section search period and the set search region are input as the search conditions; and unregistering non-drivable sections that do not overlap the first non-drivable sections among the second non-drivable sections.

The transmitting of the generated alternative map includes performing processing so that the first road map is transmitted for sections other than the non-drivable section.

The first road map is a high-precision map for autonomous driving, and the second road map is a real-time road map that is updated in real time.

According to the present disclosure, it is possible to provide an alternative map for a non-drivable section to autonomous driving vehicles so that the vehicles can travel while correcting a drivable route to a destination in real time.

According to the present disclosure, it is also possible to provide an avoidance route, i.e., an alternative road, for the non-drivable section generated in the control server and to transmit it together with the alternative map to autonomous driving vehicles, thereby enabling stable service operation within the ODD (Operational Design Domain).

According to the present disclosure, it is further possible to provide inspection and route change of level 4 autonomous vehicles (or unmanned vehicles) based on the decision of a controller in the control server, and to provide automatic delivery of the alternative map until the non-drivable section is released, thereby making it possible to effectively manage a plurality of autonomous driving vehicles.

Effects that can be obtained from the present disclosure are not limited to that described above, and other effects that have not been described will be clearly understood by those skilled in the technical field to which the present disclosure pertains from the following description.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram briefly illustrating an autonomous driving system according to an embodiment of the present disclosure;

FIG. 2 is a block diagram illustrating a first vehicle (10), which is one of a plurality of vehicles (10 to 30) illustrated in FIG. 1;

FIG. 3 is a block diagram illustrating an autonomous driving control server (100) according to an embodiment of the present disclosure;

FIG. 4 is an illustrative diagram illustrating information stored in a DB (130) illustrated in FIG. 3;

FIG. 5 is an illustrative diagram illustrating matching of a first road map (M1) with a second road map (M2);

FIGS. 6A to 6C are illustrative diagrams illustrating an operation of generating an alternative map using the second road map (M2);

FIG. 7 is a flowchart illustrating a method of controlling autonomous driving of a server (100) according to an embodiment of the present disclosure; and

FIG. 8 is a flowchart illustrating a method of unregistering a non-drivable section in the method of controlling autonomous driving of the server (100) according to an embodiment of the present disclosure.

### DETAILED DESCRIPTION OF EXEMPLARY EMBODIMENTS

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present disclosure and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

In the present disclosure, each of phrases such as “A or B”, “at least one of A and B”, “at least one of A or B”, “A, B or C”, “at least one of A, B and C”, ““at Each of the phrases such as “at least one of A, B or C” and “at least one of A, B, C or combination thereof” may include any one or all possible combinations of the items listed together in the corresponding one of the phrases.

Hereinafter, embodiments of the present disclosure will be described with reference to the accompanying drawings.

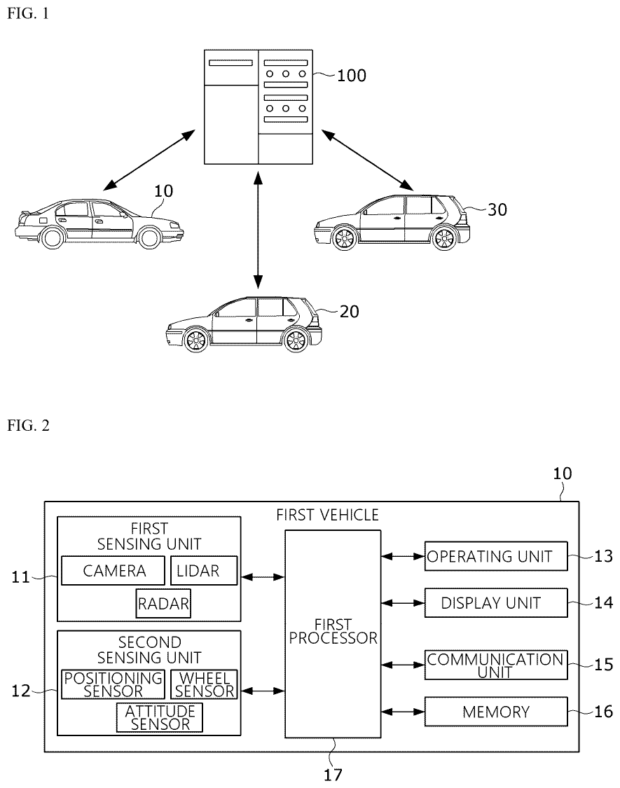

FIG. 1 is a diagram briefly illustrating an autonomous driving system according to an embodiment of the present disclosure.

Referring to FIG. 1, an autonomous driving system according to the embodiment of the present disclosure may include a plurality of vehicles 10 to 30 and an autonomous driving control server 100.

The plurality of vehicles 10 to 30 may be non-autonomous vehicles or autonomous vehicles. The non-autonomous vehicles are vehicles that are manually driven by a driver. The autonomous vehicles are vehicles capable of fully autonomous driving or semi-autonomous driving. In fully autonomous driving, a vehicle completely controls driving without driver intervention even when a driving situation is uncertain. Semi-autonomous driving requires driver intervention in some driving situations.

The plurality of vehicles 10 to 30 may detect a surrounding environment and vehicle state to acquire surrounding environment information and vehicle state information while driving, and transmit the acquired surrounding environment information and vehicle state information to the autonomous driving control server 100 regardless of whether vehicles 10 to 30 are capable of autonomous driving.

The surrounding environment information may be information on a road and surroundings of the road that are recognized by sensors of the vehicle, and may include road information, obstacle information, traffic situation information, weather information, and geographical information. [Table 1] shows examples of the surrounding environment information.

TABLE 1

| Surrounding | |
|---|---|
| environment | |
| information | Example |
| Road information | Location and number of lanes of current driving, |
| | whether lane change is possible based on type of |
| | lane (solid or dotted line), road signs, traffic |
| | light locations, nearby landmarks, and the like |
| Obstacle information | Location and movement of nearby vehicles, |
| | stopped vehicles, construction barricades, |
| | location and number of rubber cones, fallen |
| | objects on road |
| Traffic situation | Traffic congestion state, accident information, |
| information | and bypass information |
| Weather information | Weather states such as rain, snow, and fog, and |
| | road states (wet roads, ice, snow-covered roads) |
| Geographic | GPS location, altitude, gradient, curved road |
| information | information, and information on road structures |
| | such as tunnels and bridges |

The vehicle state information is information indicating the state and performance of the vehicle, and includes various types of information such as driving information, powertrain information, tire information, and internal environment information. [Table 2] shows an example of the vehicle state information.

TABLE 2

| Vehicle state | |
|---|---|
| information | Example |
| Driving information | Driving starting point and destination, vehicle |
| | speed, acceleration and deceleration states, |
| | steering wheel angle |
| Powertrain information | Battery temperature, charge level, engine RPM, |
| | and fuel amount |
| Tire information | Tire pressure, tire temperature, and slip state |
| Internal environment | Indoor temperature and humidity, air quality |
| information | (CO2, dust, and the like) inside vehicle, and seat |
| | occupancy state (passenger detection sensor) |
| Other | Whether headlights are turned on, whether doors |
| | are locked, altitude above sea level, and the like |

Further, the plurality of vehicles 10 to 30 may be vehicles that drive on the ground, and may be typical passenger vehicles, commercial vehicles, or purpose-built vehicles (PBVs). The ground vehicles may be vehicles that move on land as well as vehicles that move underground. Further, the plurality of vehicles 10 to 30 may be robots in a broad sense, such as movement means, and the robots may move using wheels, tracks, or other movement modules. Although ground mobility apparatuses such as ground vehicles are mainly described in the present disclosure, the present embodiment may also be applied to air mobility apparatuses such as advanced air mobility (AAM) and aircraft, and water mobility apparatuses such as ships and submarines, as long as this does not contradict the present disclosure.

Further, the plurality of vehicles 10 to 30 may be driven based on electric energy or fossil energy.

Further, the plurality of vehicles 10 to 30 may include one or more vehicle controllers. The vehicle controllers may be included in the form of an embedded system inside the vehicle, may be implemented as independent devices according to functions of the vehicle controllers, or may be communicatively connected to each other. The one or more controllers may be implemented in various forms such as an electronic control unit (ECU), a micro controller unit (MCU), a central processing unit (CPU), or a microprocessor.

Examples of the vehicle controller include an autonomous driving controller, an engine controller, a transmission controller, an electronic stability controller, an airbag controller, a tire pressure monitoring system controller, a motor controller, a seat controller, and a door controller.

The autonomous driving controller may be implemented in a form that is integrated with various in-vehicle functions or in a form specialized for autonomous driving. The autonomous driving controller may process sensing data (the vehicle state information and the surrounding environment information), map information, and the like in real time to control the autonomous driving. For example, the autonomous driving controller may control acceleration, braking, and steering of a first vehicle 10. To this end, the autonomous driving controller may include a first memory 16 and a first processor 17 illustrated in FIG. 2, or may include a separate memory (not illustrated) and a separate processor (not illustrated).

The autonomous driving control server 100 may be an external device operated by a vehicle manufacturer or provided to provide an autonomous driving service, and may receive connected data of the vehicles 10 to 30 or transmit and receive data required for autonomous driving. The autonomous driving control server 100 may transmit various types of information and software modules used for control of the autonomous driving vehicle among the plurality of vehicles 10 to 30 to the autonomous driving vehicle based on receiving a request and data transmitted from the autonomous driving vehicle or a driver terminal.

The autonomous driving control server 100 and the plurality of vehicles 10 to 30 may communicate with each other based on cellular communication, wireless access in vehicular environment (WAVE) communication, dedicated short range communication (DSRC), short-range communication, or any other communication scheme.

FIG. 2 is a block diagram illustrating the first vehicle 10, which is one of the plurality of vehicles 10 to 30 illustrated in FIG. 1.

Referring to FIG. 2, the first vehicle 10 according to the embodiment of the present disclosure may include a first sensing unit 11, a second sensing unit 12, an operating unit 13, a display unit 14, a communication unit 15, the first memory 16, and the first processor 17.

The first and second sensing units 11 and 12 may include various types of detectors for detecting an external environment of the first vehicle 10, an internal system, a driver operation, and a state and situation occurring in a boarding space.

The first sensing unit 11 may include one or more cameras, one or more lidars, and one or more radars to recognize dynamic and static objects existing outside the first vehicle 10 and generate surrounding environment information. The camera may recognize an external object as a video during use of the first vehicle 10 to generate video data, and transmit the video data to the first processor 17. In order to generate three-dimensional spatial information for identifying a shape of an external object, the lidar may generate point cloud data obtained by recognizing the external object and transmit the point cloud data to the first processor 17. In order to ascertain the presence of an external object and a relative distance, speed, direction, and the like, the radar may emit radio waves at a specific frequency around the first vehicle 10 and generate radar data through radio waves reflected from the external object.

The surrounding environment information may also include data detected for the non-drivable section when the first vehicle 10 encounters the non-drivable section while driving and drives on a temporary road prepared around the non-drivable section. The non-drivable section is a road section where traffic is not smooth due to a traffic accident, a breakdown of another vehicle, road construction, a natural disaster, or the like.

For example, in the case of a traffic accident, the data detected for the non-drivable section includes data from which traffic accident circumstances can be predicted, such as data obtained by recognizing vehicles involved in the traffic accident, rubber cones installed around the site of the traffic accident, and lanes on which driving is not possible due to the traffic accident.

For example, in the case of breakdown of another vehicle, the detected data for the non-drivable section may include data obtained by recognizing the vehicle that has stopped due to the breakdown, rubber cones, lanes on which driving is not possible due to the broken down vehicle, and the like.

For example, in the case of road construction, data obtained by recognizing equipment and people who perform the construction, rubber cones, and lanes that cannot be used due to the road construction may be included.

The second sensing unit 12 may generate the vehicle state information based on sensing data. The vehicle state information may be information generated based on data detected by various sensors included in the vehicle. For example, the vehicle state information may include vehicle attitude information, vehicle wheel speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, route information, and the like.

For example, the second sensing unit 12 may include a positioning sensor, a wheel sensor, and an attitude sensor to detect a location, speed, and driving attitude. The positioning sensor detects a current location of the first vehicle 10. The wheel sensor detects an acceleration or angular velocity of a wheel included in the first vehicle 10. The attitude sensor may be an inertial measurement unit (IMU) sensor and may detect an acceleration (x, y, and z directions) and an angular velocity of the first vehicle 10.

The operating unit 13 may include a module allowing the driver to control the first vehicle 10. For example, the operating unit 13 may be a steering wheel for manual driving, an automatic or manual transmission, an accelerator pedal, a brake pedal, and the like. Further, to use the autonomous driving function, the operating unit 13 may further include an interface for using, releasing, and selecting detailed functions of an autonomous driving mode requested by the driver.

The display unit 14 may display an operation state and control state of the first vehicle 10, route/traffic information, remaining energy information, content requested by the driver, a navigation screen, and the like under the control of the first processor 17. The navigation screen may provide at least one of a driving route to a destination set by the driver, information on various objects on the route, lane information, map information, and current location information of the vehicle. Further, the display unit 14 may further include a touch screen to receive a request from the driver.

The communication unit 15 supports mutual communication with the server 100, other nearby vehicles, and an electronic terminal in the first vehicle 10. For example, the communication unit 15 may transmit the vehicle state information and the surrounding environment information to the server 100 and receive a first road map M1 or a second road map M2 from the server 100.

The communication unit 15 may perform communication based on cellular communication, WAVE communication, DSRC, short-range communication, or any other communication scheme. To this end, the communication unit 15 may include at least one of a short-range communication module, a wired communication module, and a wireless communication module.

For example, the short-range communication module may include various communication modules that transmit and receive signals using a wireless communication network in a short range, such as a Bluetooth module, an infrared communication module, a radio frequency identification (RF ID) communication module, a wireless local access network (WLAN) communication module, an NFC communication module, and a Zigbee communication module.

For example, the wired communication module may include various modules such as a controller area network (CAN) module, a local interconnect network (LIN) module, a local area network (LAN) module, a wide area network (WAN) module, a value added network (VAN) module, Universal Serial Bus (USB), High Definition Multimedia Interface (HDMI), Digital Visual Interface (DVI), a Recommended Standard 232 (RS-232), power line communication, and plain old telephone service (POTS).

For example, the wireless communication module may include a module that supports various wireless communication schemes such as Global System for Mobile Communication (GSM), code division multiple access (CDMA), wideband code division multiple access (WCDMA), Universal Mobile Telecommunications System (UMTS), time division multiple access (TDMA), and Long Term Evolution (LTE), in addition to a WiFi module and a wireless broadband (Wibro) module.

The operating unit 13, the display unit 14, and the communication unit 15 may constitute a part of an audio, video, navigation, telematics (AVNT) system.

The first memory 16 may store at least one program (for example, an operating system, software, firmware, middleware, or an application), various types of data, and at least one instruction for control of the first vehicle 10, and may load the program, read or record data, or perform an operation corresponding to the instruction in response to a request from the first processor 17. The first memory 16 may include a volatile memory and a nonvolatile memory.

For example, the first memory 16 may store a large amount of sensing data (for example, the vehicle state information and the surrounding environment information) and map information, and provide the sensing data and the map information to the first processor 17 so that an operation related to autonomous driving can be performed. The large amount of sensing data may include data detected by the first and second sensing units 11 and 12.

The first processor 17 may perform overall control of the first vehicle 10 according to an input instruction. The instruction may be input to the first processor 17 through the first memory 16 or the communication unit 15. For example, the first processor 17 may execute a program or instruction stored in the first memory 16 to control an operation of other components (hardware or software) connected to the first vehicle 10 and perform data processing and computation.

Further, the first processor 17 may load an instruction or data received from another component (for example, the sensing unit 11 or 12 or the communication unit 15) into a volatile memory, process the instruction or data stored in the volatile memory, and store a processing result in a nonvolatile memory.

Further, the first processor 17 may control the communication unit 15 so that the communication unit 15 transmits sensing data (for example, the vehicle state information and the surrounding environment information) from the first and second sensing units 11 and 12 to the autonomous driving control server 100 periodically or in real time.

Further, the first processor 17 may analyze and process the sensing data to recognize and fuse objects, display the data on the display unit 14, and provide the vehicle state (current location, dynamic information, and the like) to the driver.

Further, the first processor 17 may display the first road map M1 received from the server 100 on the display unit 14 to provide guidance on the route.

Further, the first processor 17 may control the autonomous driving of the first vehicle 10 based on the first road map M1 and the sensing data received from the server 100 when the first vehicle 10 is an autonomous driving vehicle. The first processor 17 may control autonomous driving by processing the vehicle state information, surrounding environment information, map information, and the like in real time. For example, the first processor 17 may display a surroundings map including a driving route based on at least one of the first road map M1 and the second road map M2 transmitted from the autonomous driving control server 100, and control acceleration, braking, and steering of the first vehicle 10.

Further, the first processor 17 generates a driving route based on the first road map M1, displays the second road map M2 on the display unit 14 when the second road map M2 is received from the server 100 during control of autonomous driving, generates an alternative route based on the second road map M2, and controls route guidance and autonomous driving. The second road map M2 is a map for guiding the vehicle to drive along a new route when a route change is required, as in the non-drivable section.

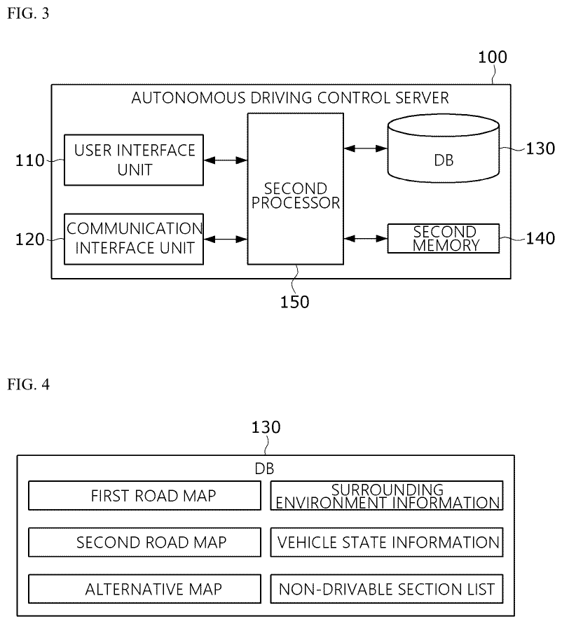

FIG. 3 is a block diagram illustrating the autonomous driving control server 100 according to an embodiment of the present disclosure, and FIG. 4 is an illustrative diagram illustrating information stored in the DB 130 illustrated in FIG. 3.

Referring to FIG. 3, the autonomous driving control server 100 according to an embodiment of the present disclosure may include a user interface unit 110, a communication interface unit 120, the DB 130, a second memory 140, and a second processor 150.

The user interface unit 110 may transfer an instruction input from the administrator of the server 100 to the second processor 150 and display a processing result of the second processor 150 so that the administrator can recognize the processing result. The user interface unit 110 may include an operation panel such as a keyboard, and a monitor device. For example, when a non-drivable section is found, the administrator may use the user interface unit 110 to create information on the non-drivable section including a non-drivable period and then map the information with the alternative map to be described later.

The communication interface unit 120 may receive the vehicle state information and the surrounding environment information from the plurality of vehicles 10 to 30 and transmit the vehicle state information and the surrounding environment information to the second processor 150. Further, the communication interface unit 120 transmits the first road map M1 to autonomous vehicles among the plurality of vehicles 10 to 30. Further, the communication interface unit 120 may transmit the second road map M2 corresponding to the non-drivable section to the autonomous vehicle predicted to pass through the non-drivable section when the non-drivable section occurs. The transmitted second road map M2 may be a map for a local section including the non-drivable section. The communication interface unit 120 may perform communication based on cellular communication, WAVE communication, DSRC, short-range communication, or any other communication scheme, similar to the communication unit 15.

The DB 130 may store the first road map M1, the second road map M2, the surrounding environment information, the vehicle state information, the alternative map, and a non-drivable section list.

The first road map M1 is a default map that is transmitted to one or more autonomous vehicles among the plurality of vehicles 10 to 30. In other words, the first road map M1 may be a map that is set to be transmitted as a default for route guidance to the autonomous vehicles. For example, the first road map M1 may be a high definition (HD) map that is provided for autonomous driving, and may include connection information between lane links or lane sides. Further, the first road map M1 may include detailed information such as lanes, traffic lights, signs, road boundaries, and 3D terrain. The first road map M1 is precisely created using schemes based on lidar, radar, cameras, and aerial photography, or the like and may be created in the form of high-resolution 3D data. Further, the first road map M1 is regularly updated, and may not reflect road changes in real time since an update cycle is longer than that of the second road map M2.

The second road map M2 may be a real-time road map that is updated in real time based on the surrounding environment information received from the plurality of vehicles 10 to 30. The second road map M2 may be created using a cloud sourcing scheme based on vehicle sensors (cameras, lidar, radar, and the like) and may be created with a relatively low capacity compared to the first road map M1. Since the second road map M2 is updated in real time, the second road map M2 may reflect a road situation such as road construction, a signal change, and a lane change in real time. Therefore, a road in the non-drivable section of the second road map M2 may be changed based on the surrounding environment information detected while the vehicles passing through the non-drivable section bypass the non-drivable section.

The surrounding environment information and the vehicle state information are information received from the plurality of vehicles 10 to 30 and have been described in detail with reference to [Table 1] and [Table 2].

The alternative map is the second road map M2 that is transmitted to autonomous vehicles that will pass through the non-drivable section when the non-drivable section occurs. Basically, the first road map M1 is transmitted in local units into which an entire map corresponding to a global route is divided. The local unit may be designated by the administrator or set automatically. For example, the map in the local unit may be a map that is transmitted in a single grid unit generated by dividing the entire map into grid forms, or a map that is transmitted by dividing the entire map into road structures (nodes and segments). Therefore, the alternative map may also be the second road map M2 that is transmitted in the same local units.

The alternative map may be mapped with the non-drivable section list and stored. The non-drivable section list includes location information of a region in which the non-drivable section has occurred, a non-drivable period of the non-drivable section, a non-drivable section name, and location information, and may be stored in the DB 130.

The second memory 140 may store at least one program (for example, an operating system, software, firmware, middleware, or an application), various types of data, and at least one instruction for control of the server 100, and may load the program, read or record the data, or perform an operation corresponding to the instruction in response to a request from the second processor 150.

Further, the second memory 140 may include at least one of storage media such as a random access memory (RAM), a static random access memory (SRAM), a read only memory (ROM), a programmable read only memory (PROM), an electrically erasable and programmable ROM (EEPROM), an erasable and programmable ROM (EPROM), a hard disk drive (HDD), a solid state disk (SSD), an embedded multimedia card (eMMC), a universal flash storage (UFS), and/or a web storage.

The second processor 150 may perform overall control of the server 100 according to an input instruction. For example, the second processor 150 may execute the program or instructions stored in the second memory 140 to control an operation of other components (hardware or software) and perform data processing and computation. Further, the second processor 150 may load instructions or data received from other components into a volatile memory, process the instructions or data stored in the volatile memory, and store processing results in a nonvolatile memory.

The second processor 150 may include, for example, at least one of processing devices such as a central processing unit (CPU), a digital signal processor (DSP), an application specific integrated circuit (ASIC), a programmable logic device (PLD), a field programmable gate array (FPGA), a microcontroller, and/or a microprocessor.

The second processor 150 may store the vehicle state information and the surrounding (or adjacent) environment information received from the plurality of vehicles 10 to 30 in the DB 130, periodically update the first road map M1, update the second road map M2 in real time, and store the alternative map that is transmitted to the autonomous vehicles, in the DB 130.

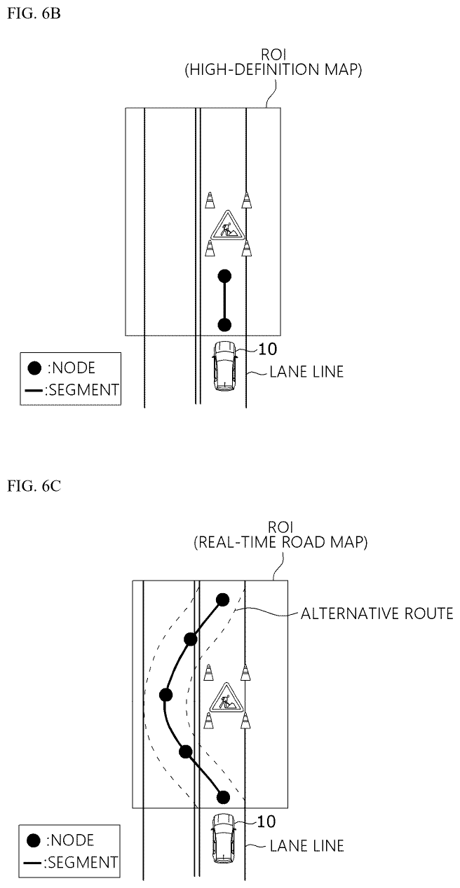

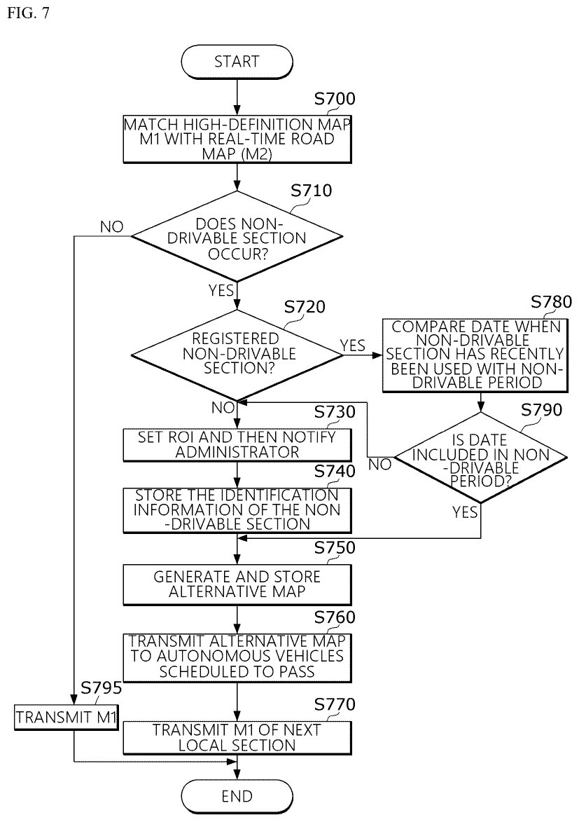

Further, the second processor 150 may change a driving road in the non-drivable section in the second road map M2 in real time based on the surrounding environment information collected from the vehicles 10 to 30 that have bypassed the non-drivable section (see FIG. 6C). Therefore, the second processor 150 may confirm whether the non-drivable section has occurred by matching the first road map M1 with the second road map M2, create a bypass road, that is, an alternative road, and update the second road map M2 so that the alternative road is reflected.

Further, the second processor 150 may support autonomous driving by transmitting the first road map M1 to the autonomous vehicles among the plurality of vehicles 10 to 30. Further, when the non-drivable section occurs, the second processor 150 may transmit the alternative map rather than the first road map M1 to the autonomous vehicles predicted to pass through the non-drivable section, and may transmit the first road map M1 again after the non-drivable section. Hereinafter, a case in which an example of an autonomous vehicle scheduled to drive through the non-drivable section is the first vehicle 10 described with reference to FIG. 2 will be described.

Specifically, when a non-drivable section with mismatch in the vehicle route confirmed as a result of matching the first road map M1 with the second road map M2 occurs, that is, when the matching fails, the second processor 150 may generate an alternative map and perform processing so that the generated alternative map is transmitted to the first vehicle 10. The alternative map may include an alternative route, and when the alternative map does not include an alternative route, the vehicle may use the alternative map to generate an alternative route. This is possible because the alternative map is a map of a local region including the region of interest in the second road map M2, and is a map in which the driving road is modified due to the non-drivable section.

Further, when the non-drivable section is an unregistered non-drivable section, the second processor 150 may register the non-drivable section in the non-drivable section list and generate the alternative map corresponding to the non-drivable section based on the second road map M2.

Alternatively, when the non-drivable section is the unregistered non-drivable section, the second processor 150 may set a region of interest including the non-drivable section on the first road map M1 or the second road map M2, notify the administrator that the non-drivable section has occurred, and register the non-drivable section in the non-drivable section list in response to a request from the administrator. The second processor 150 may notify the administrator of the occurrence of the non-drivable section through a mobile terminal of the administrator or the user interface unit 110, and the administrator may register the non-drivable section by accessing the server 100 using the mobile terminal or operating the user interface unit 110. The user interface unit 110 will be described below as an example.

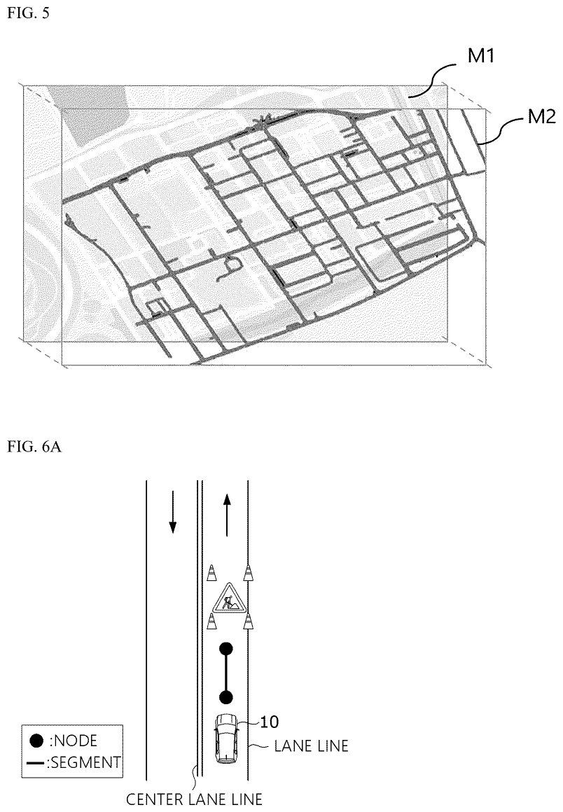

FIG. 5 is an illustrative diagram illustrating matching of the first road map M1 with the second road map M2.

Referring to FIG. 5, as an example, the second processor 150 may match (that is, overlap) each lane link of the first road map M1 with latitude and longitude coordinates of the second road map M2, and then search for a point with a mismatch in a driving route.

FIGS. 6A to 6C are illustrative diagrams illustrating an operation of generating the alternative map using the second road map M2.

In FIGS. 6A to 6C, nodes and segments are components of the first road map M1, and a segment is a connection of the nodes. The nodes and segments may be used to generate or provide guidance on a driving route of the autonomous vehicle.

Referring to FIG. 6A, when the first vehicle 10 drives autonomously based on the first road map M1 and a non-drivable section (construction section) appears in front, the first vehicle 10 cannot drive along a planned route and it may also be difficult to change the driving route to an opposite lane. This is because the first road map M1 does not reflect the presence of the non-drivable section and therefore still shows a road passing through the non-drivable section. Therefore, the second processor 150 may match the first road map M1 with the second road map M2 periodically or in real time to determine whether the non-drivable section has occurred.

Referring to FIGS. 6B and 6C, when the second processor 150 determines that the non-drivable section is not registered in the non-drivable section list, the second processor 150 may set a region of interest (ROI) on the first and second road maps M1 and M2. The second processor 150 sets the ROI set on the first road map M1 at the same location on the second road map M2. The second processor 150 may set the ROI to include the non-drivable section and a region around the non-drivable section. This is intended to be used when an alternative route is created. The second processor 150 may confirm whether a non-drivable section having the same location information as the location information of the non-drivable section is registered in the non-drivable section list.

The second processor 150 may display the first and second road maps M1 and M2 on which the ROI including the non-drivable section is indicated on the user interface unit 110. The administrator may confirm whether the non-drivable section has actually occurred, and when it is confirmed that the non-drivable section has actually occurred, the administrator may input identification information of the non-drivable section by operating the user interface unit 110. The identification information of the non-drivable section includes a non-drivable period, a non-drivable section name, and a location of the non-drivable section, the non-drivable period is a period during which the non-drivable section is maintained, and the non-drivable section name is a name of the non-drivable section. For example, when the non-drivable section is under road construction, the administrator may confirm a construction period from a road construction company and input the construction period as the non-drivable period. When the non-drivable section is a traffic accident, the administrator may confirm a scale of the traffic accident and input the non-drivable period according to a determined guide. The non-drivable section name may be directly input by the administrator or location information such as a latitude and longitude may be automatically input.

The second processor 150 may generate the alternative map including the non-drivable section from the second road map M2, and map the identification information of the non-drivable section input by the administrator with the alternative map to store them in the DB 130. For example, the second processor 150 may confirm a local region including the non-drivable section, and extract map data corresponding to the confirmed local region from the second road map M2 to generate the alternative map.

The second processor 150 may transmit the generated alternative map to the first vehicle 10, and then transmit the first road map M1 as a road map of the local region. For example, the second processor 150 may generate the alternative route based on the changed road and transmit the alternative route to the first vehicle 10 or may transmit the alternative map without an alternative route to the first vehicle 10. For example, the second processor 150 may connect nodes included in a new bypass road as shown in FIG. 6C using segments to generate an alternative route.

When the first vehicle 10 receives the alternative map including the alternative route, the first vehicle 10 may display the previously received first road map M1 and then display the alternative map in the section corresponding to the alternative map. When the alternative route is not included in the alternative map, the first vehicle 10 may generate a driving route by bypassing the non-drivable section based on the alternative map and then provide guidance.

Further, when the non-drivable section has already been registered in the non-drivable section list, the second processor 150 may confirm a driving date of the autonomous vehicle that has most recently driven along the alternative route of the non-drivable section from the DB 130, and when the confirmed driving date falls within a preset non-drivable period, the second processor 150 may perform processing so that the already generated alternative map is transmitted to the first vehicle 10. In other words, since the non-drivable section has already been registered, the second processor 150 may transmit the alternative map without an administrator confirmation procedure.

Further, when the confirmed driving date does not fall within the preset non-drivable period, the second processor 150 may set an ROI including the non-drivable section on the first and second road maps M1 and M2, notify the administrator that the non-drivable section has reoccurred, and re-register the non-drivable section in the non-drivable section list in response to a request from the administrator.

Meanwhile, the second processor 150 may unregister the non-drivable section before a non-drivable period of a previously registered non-drivable section arrives. To this end, the second processor 150 may match road maps corresponding to the search region between the first road map M1 and the second road map M2 to confirm the first non-drivable sections present in the search region. The non-drivable section search period and the search region may be input by the administrator or automatically set by the second processor 150.

When the non-drivable section search period and the search region are input as search conditions, the second processor 150 confirms second non-drivable sections corresponding to the search conditions from the stored non-drivable section list. That is, the second processor 150 confirms the second non-drivable sections currently being transmitted by the alternative map. The second processor 150 may unregister the non-drivable sections that do not overlap the first non-drivable sections among the confirmed second non-drivable sections. This is intended to provide a recovered road map, that is, the first road map M1, to autonomous vehicles by unregistering the non-drivable section from the non-drivable section list when the non-drivable section disappears sooner than the non-drivable period registered by the administrator in advance.

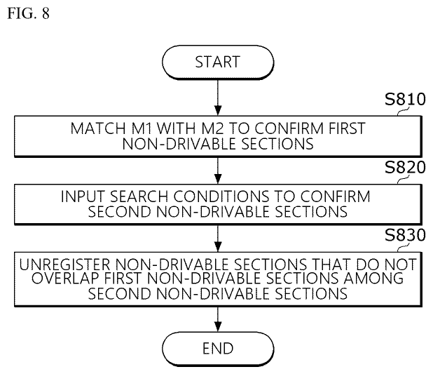

FIG. 7 is a flowchart illustrating a method of controlling autonomous driving for a server 100 according to an embodiment of the present disclosure.

Referring to FIG. 7, the server 100 may match the first road map M1 with the second road map M2, both of which are stored in the DB 130 (S700). The first road map M1 may be a high-precision map, and the second road map M2 may be a map that is updated in real time. For example, when the plurality of vehicles 10 to 30 drive on a bypass road in the non-drivable section, the second road map may change the driving road in the non-drivable section in real time based on the sensing data received from the plurality of vehicles 10 to 30. Accordingly, based on the sensing data received from the vehicle that has bypassed the non-drivable section, the second road map may provide a different road from the first road map in the non-drivable section.

When a non-drivable section with a mismatch in a vehicle route, that is, a road confirmed as a result of matching in operation S700, occurs (S710—Yes), the server 100 may confirm whether the non-drivable section has already been registered in the non-drivable section list (S720). It may be determined in operation S720 that a non-drivable section at the same location as the non-drivable section has already been previously registered when the non-drivable section is in the non-drivable section list.

When the non-drivable section has not been previously registered (S720—No), the server 100 may set an ROI on the first and second road maps M1 and M2 and then notify the administrator of this (S730).

The administrator may verify whether the non-drivable section actually occurs from the first and second road maps M1 and M2 in which the ROI has been set, and the server 100 may store the identification information of the non-drivable section input by the administrator (S740). The identification information of the non-drivable section includes a non-drivable period, a non-drivable section name, and location information of the non-drivable section.

The server 100 may generate the alternative map for the non-drivable section in response to a request from the administrator, map the generated alternative map to the identification information of the non-drivable section, and store this in the DB 130 (S750). Accordingly, the non-drivable section confirmed in operation S710 is registered in the non-drivable section list together with the identification information. The alternative map may be generated based on map data including the non-drivable section in the second road maps M2. In operation S750, the server 100 generates an alternative map of a local region including the non-drivable section.

The server 100 may transmit the alternative map to autonomous vehicles scheduled to pass through the non-drivable section (S760). In operation S760, the server 100 may confirm autonomous vehicles scheduled to pass through the non-drivable section from the vehicle state information collected from the plurality of vehicles 10 to 30. The vehicle (for example, the first vehicle 10) that has received the alternative map in operation S760 may provide guidance on the route based on the first road map M1, display the alternative map in a local section including the non-drivable section, generate an alternative route based on the alternative map, and provide guidance on the alternative route.

The server 100 may then transmit the first road map M1 of the next local section to the autonomous vehicles (S770). The next local section is a section that is connected to the local section included in the alternative map in operation S750.

On the other hand, when it is confirmed in operation S720 that the non-drivable section has been previously registered (S720—Yes), the server 100 confirms a date of the most recent driving of the alternative route of the non-drivable section and compares the confirmed driving date with the preset non-drivable period (S780).

The server 100 may perform operation S750 when the confirmed driving date is included in the preset non-drivable period (S790—Yes), and may perform operation S730 when the confirmed driving date is not included (S790—No). That is, when the confirmed driving date is not included, the server 100 may set an ROI including the non-drivable section, notify the administrator that the non-drivable section has reoccurred, and re-register the non-drivable section in the non-drivable section list.

Further, when it is confirmed that the non-drivable section has not occurred as a result of the matching in operation S700 (S710—No), the server 100 transmits the first road map to the autonomous vehicles (S795).

FIG. 8 is a flowchart illustrating a method of unregistering a non-drivable section in the method of controlling autonomous driving for the server 100 according to an embodiment of the present disclosure.

Referring to FIG. 8, the server 100 sets a search region and matches the first road map M1 with the second road map M2 in the set search region to confirm the first non-drivable sections (S810). The search region may include one or more local sections.

When the non-drivable section search period and the search region are input as search conditions, the server 100 may confirm the second non-drivable sections corresponding to the search conditions from the non-drivable section list stored in the DB 130 (S820).

The server 100 may unregister the non-drivable sections that do not overlap the first non-drivable sections among the confirmed second non-drivable sections and transmit the first road map (S830).

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. An autonomous driving control server comprising:
a processor; and
a memory configured to store one or more programs executed by the processor, the processor configured to identify a non-drivable section in which a vehicle route is mismatched as a result of matching a first road map and a second road map, generate an alternative map including an alternative road for the non-drivable section, and transmit the alternative map to autonomous driving vehicles to control autonomous driving operation of the autonomous driving vehicles, wherein the first road map is a default map transmitted to the autonomous driving vehicles.

2. The autonomous driving control server of claim 1, wherein the processor registers the non-drivable section based on determining that the non-drivable section is an unregistered non-drivable section, generates the alternative map corresponding to the non-drivable section based on the second road map, and transmits the alternative map corresponding to the non-drivable section to an autonomous driving vehicle scheduled to drive through the non-drivable section.

3. The autonomous driving control server of claim 1, wherein the processor sets a region of interest including the non-drivable section based on determining that the non-drivable section is an unregistered non-drivable section, displays a notification that the non-drivable section has occurred, and registers the non-drivable section based on receiving a registration request.

4. The autonomous driving control server of claim 3, wherein the processor maps a non-drivable period input based on the registration request with the registered non-drivable section and stores the non-drivable period, wherein the non-drivable period is a period during which the non-drivable section is maintained.

5. The autonomous driving control server of claim 1, wherein the processor transmits the alternative map to the autonomous driving vehicles based on determining that the non-drivable section is a previously registered non-drivable section and that a driving date of an autonomous vehicle that has most recently driven along an alternative route of the non-drivable section falls within a preset non-drivable period, wherein the non-drivable period is a period during which the non-drivable section is maintained.

6. The autonomous driving control server of claim 5, wherein the processor sets a region of interest including the non-drivable section and then displays a notification that the non-drivable section has reoccurred based on determining that the driving date does not fall within the preset non-drivable period, and re-registers the non-drivable section based on receiving a re-register request.

7. The autonomous driving control server of claim 1, wherein the processor transmits the first road map to the autonomous driving vehicles based on a determination that the non-drivable section is unregistered.

8. The autonomous driving control server of claim 1, wherein the processor is configured to:
confirm first non-drivable sections in a set search region by matching road maps corresponding to the search region between the first road map and the second road map,
confirm second non-drivable sections corresponding to search conditions when a drivable section search period and the search region are input as the search conditions, and
unregister non-drivable sections that do not overlap the first non-drivable sections among the second non-drivable sections.

9. The autonomous driving control server of claim 1, wherein for sections other than the non-drivable section, the processor transmits the first road map to the autonomous driving vehicles.

10. The autonomous driving control server of claim 1, wherein the first road map is a high-precision map for autonomous driving, and the second road map is a real-time road map that is updated in real time.

11. A method of controlling autonomous driving, the method comprising:
matching a first road map with a second road map;
generating an alternative map including an alternative road for a non-drivable section based on confirming the non-drivable section in which a vehicle route is mismatched as a result of matching a first road map and a second road map, and
controlling autonomous driving operation of autonomous driving vehicles based on the alternative map,
wherein the first road map is a default map transmitted to the autonomous driving vehicles.

12. The method of controlling autonomous driving of claim 11, wherein, based on determining that the non-drivable section is an unregistered non-drivable section, the generating of the alternative map includes:
registering the non-drivable section; and
generating the alternative map corresponding to the non-drivable section from the second road map.

13. The method of controlling autonomous driving of claim 11, wherein, based on determining that the non-drivable section is an unregistered non-drivable section, the generating of the alternative map includes:
setting a region of interest including the non-drivable section and then displaying a notification that the non-drivable section has occurred; and
registering a non-drivable section based on receiving a register request.

14. The method of controlling autonomous driving of claim 13, wherein the generating of the alternative map further includes mapping a non-drivable period input based on the register request with the registered non-drivable section and storing the non-drivable period, the non-drivable period being a period during which the non-drivable section is maintained.

15. The method of controlling autonomous driving of claim 11, wherein, based on determining that the non-drivable section is a previously registered non-drivable section, the generating of the alternative map includes transmitting the generated alternative map to the autonomous driving vehicles based on determining that a driving date of the autonomous driving vehicle that has most recently driven along the alternative route of the non-drivable section falls within a preset non-drivable period, wherein the non-drivable period is a period during which the non-drivable section is maintained.

16. The method of controlling autonomous driving of claim 15, further comprising:
setting a region of interest including the non-drivable section and then displaying a notification that the non-drivable section has reoccurred based on determining that the driving date does not fall within the preset non-drivable period; and
re-registering the non-drivable section based on receiving a re-register request.

17. The method of controlling autonomous driving of claim 11, further comprising:
unregistering the non-drivable section; and
transmitting the first road map to the autonomous driving vehicles.

18. The method of controlling autonomous driving of claim 17, wherein the unregistering of the non-drivable section includes:
confirming first non-drivable sections in a set search region by matching road maps corresponding to the set search region between the first road map and the second road map;
confirming second non-drivable sections corresponding to search conditions when a drivable section search period and the set search region are input as the search conditions; and
unregistering non-drivable sections that do not overlap the first non-drivable sections among the second non-drivable sections.

19. The method of controlling autonomous driving of claim 11, wherein the transmitting of the generated alternative map includes performing processing so that the first road map is transmitted for sections other than the non-drivable section.

20. The method of controlling autonomous driving of claim 11, wherein the first road map is a high-precision map for autonomous driving, and the second road map is a real-time road map that is updated in real time.
